(19) United States
(12) Patent Application Publication
(10) Pub. No.: US 2017/0355044 A1
(43) Pub. Date: Dec. 14, 2017

(54) FLUX-CORED WIRE AND METHOD FOR MANUFACTURING WELDED JOINT

(71) Applicant: Kabushiki Kaisha Kobe Seiko Sho (Kobe Steel, Ltd.), Kobe-shi (JP)

(72) Inventors: Naoki MUKAI, Fujisawa-shi (JP); Minoru MIYATA, Fujisawa-shi (JP); Reiichi SUZUKI, Fujisawa-shi (JP)

(73) Assignee: Kabushiki Kaisha Kobe Seiko Sho (Kobe Steel, Ltd.), Kobe-shi (JP)

(21) Appl. No.: 15/535,261

(22) PCT Filed: Nov. 30, 2015
(86) PCT No.: PCT/JP2015/083621

§ 371 Date: Jun. 12, 2017

(30) Foreign Application Priority Data
Dec. 12, 2014 (JP) 2014-251707

(51) Int. Cl. B23K 35/368; B23K 35/02; B23K 35/30; B23K 9/173

(52) U.S. Cl. CPC B23K 35/368; B23K 9/173; B23K 35/0266; B23K 35/30

(57) ABSTRACT

Provided is a flux-cored wire which can be MIG-welded at any welding position using a pure Ar gas as a shielding gas. A flux-cored wire having a flux filled in the outer skin thereof, wherein TiO₂, Al₂O₃, SiO₂ and ZrO₂ are contained in amounts of 4.7 to 8.5% by mass, 0.5 to 3.5% by mass, 0.5 to 2.0% by mass and 0.8 to 3.0% by mass, respectively, and metal oxides are also contained in the total amount of 8.0 to 13.5% by mass all relative to the total mass of the wire, and the amount of a metal fluoride is limited to 0.02% by mass or less (including 0% by mass).

### TECHNICAL FIELD

The present invention relates to a flux-cored wire and a method for manufacturing a welded joint using the flux-cored wire.

### BACKGROUND ART

Flux-cored wires including an outer skin filled with a flux are widely used in gas-shielded arc welding. In such flux-cored wires, from various viewpoints of stability of the arc during welding, welding workability, improvement in the quality of welded joints, etc., various studies have been conducted on, for example, the compositions and structures of the flux-cored wires.

For example, Patent Literature 1 discloses a technology relating to a welding wire which has a melting point distribution in the radial direction or in which an uneven temperature distribution in the radial direction is formed during welding in order that an arc be stable in a pure inert gas and a high-quality joint be obtained.

For example, Patent Literature 2 discloses a technology relating to a flux-cored wire for stainless steel welding, the flux-cored wire having a particular composition, in order to realize, for example, all-position welding including an overhead position and good welding workability.

### CITATION LIST

### Patent Literature

PTL 1: Japanese Unexamined Patent Application Publication No. 2006-205204

PTL 2: Japanese Unexamined Patent Application Publication No. 3-81094

### SUMMARY OF INVENTION

### Technical Problem

For example, construction of a fixed pipe made of stainless steel mainly includes welding on site such as a plant construction site. Therefore, it is desirable that the pipe have welding suitability at any welding position such as a flat position, a horizontal position, a vertical position, and an overhead position. In addition, since the welding of piping is often performed in high places, for example, the transportation of welding apparatuses and gas cylinders necessary for the welding may be an important issue.

In the welded joint construction of a fixed pipe made of stainless steel, a combination of welding techniques is usually employed in which a first layer is formed by tungsten inert gas (TIG) welding, and remaining layers are formed by metal active gas (MAG) welding. It is necessary to prepare different shielding gases and welding materials for TIG welding and MAG welding. In consideration that the welding can be continuously performed, large cylinders of the shielding gases are generally used. For example, a cylinder having a capacity of 7,000 L is large and heavy, i.e., has a height of about 150 cm and a weight of about 60 kg. The transportation of such a cylinder requires a lot of work.

In view of this, the present invention provides a flux-cored wire which can be metal inert gas (MIG)-welded at any welding position using a pure Ar gas as a shielding gas.

### Solution to Problem

The present invention provides a flux-cored wire including an outer skin filled with a flux, in which the wire contains, relative to a total mass of the wire, TiO₂: 4.7 to 8.5% by mass, Al₂O₃: 0.5 to 3.5% by mass, SiO₂: 0.5 to 2.0% by mass, and ZrO₂: 0.8 to 3.0% by mass, a total amount of metal oxides is 8.0 to 13.5% by mass, and an amount of metal fluoride is limited to 0.02% by mass or less (inclusive of 0% by mass).

As the flux-cored wire, a wire having an outer diameter of 1.0 to 1.6 mm may be used. The flux-cored wire may be used, for example, for welding a tubular component.

The present invention further provides a method for manufacturing a welded joint, the method including performing MIG welding with the above flux-cored wire using a pure Ar gas as a shielding gas.

### Advantageous Effects of Invention

According to the present invention, TiO₂, Al₂O₃, SiO₂, ZrO₂, and metal oxides are contained in particular amounts, and a content of a metal fluoride is limited. Therefore, it is possible to provide a flux-cored wire which can be MIG-welded at any welding position using a pure Ar gas as a shielding gas.

### BRIEF DESCRIPTION OF DRAWING

FIG. 1 is a view illustrating a groove shape of a steel sheet used in Examples.

### DESCRIPTION OF EMBODIMENTS

Hereinafter, embodiments for carrying out the present invention will be described in detail. However, the present invention is not limited to the embodiments described below.

### <Flux-Cored Wire>

A flux-cored wire of the present embodiment is a wire that includes an outer skin filled with a flux and may be referred to as FCW. The flux-cored wire of the present embodiment contains, relative to a total mass of the wire, 4.7 to 8.5% by mass of TiO₂, 0.5 to 3.5% by mass of Al₂O₃, 0.5 to 2.0% by mass of SiO₂, and 0.8 to 3.0% by mass of ZrO₂, in which a total amount of metal oxides is 8.0 to 13.5% by mass, and a content of a metal fluoride is limited to 0.02% by mass or less (inclusive of 0% by mass). These components are components contained as flux components in the flux-cored wire.

Use of the flux-cored wire of the present embodiment is not particularly limited. However, the flux-cored wire of the present embodiment is suitably used for welding of tubular components, and more suitably used for welding of fixed pipes made of stainless steel or welding of piping.

In the welding of, for example, fixed pipes made of stainless steel, multi-layer welding is generally performed in which welding beads of two or more layers (layers of weld metal formed by at least one pass) are stacked. The multi-layer welding is performed by a method in which a first, layer to the last layer are formed by TIG welding or a method in which a first layer is formed by TIG welding and a second layer and subsequent layers are formed by MAG welding using an Ar—CO₂ mixed gas or CO₂ gas as a shielding gas.

In the method in which a first layer to the last layer are formed by TIG welding, only one type of welding material and one type of shielding gas are used, but the working efficiency is not good because the melting rate of a wire is low due to TIG welding.

In the method in which a first layer is formed by TIG welding and a second layer and subsequent layers are formed by MAG welding using an Ar—CO₂ mixed gas or CO₂ gas as a shielding gas, two types of welding materials and two types of shielding gases are used in the first layer and the second and subsequent layers. For example, in working sites such as the plant construction sites or the high places, the transportation of welding apparatuses and gas cylinders requires a lot of work, and there may be a difficulty in portability (ease of transportation) on site.

In contrast, in the flux-cored wire of the present embodiment, TiO₂, Al₂O₃, SiO₂, ZrO₂, and metal oxides are contained in particular amounts, and a content of a metal fluoride is limited. Therefore, MIG welding can be performed at any welding position using a pure Ar gas as a shielding gas. As a result, the number of types of gas necessary for welding of a fixed pipe made of stainless steel can be reduced to reduce the number of gas cylinders having a large mass, and thus the portability improves. Furthermore, when the flux-cored wire of the present embodiment is applied to TIG welding of a first layer, it is only necessary to use one type of welding material. This is also advantageous in that the management of the raw materials is simplified.

For example, a first layer can be formed by TIG welding using a pure Ar gas as a shielding gas, and a second layer and subsequent layers can be formed by MIG welding with the flux-cored wire of the present embodiment using a pure Ar gas as a shielding gas. Alternatively, a first layer can be formed by semiautomatic TIG welding with the flux-cored wire of the present embodiment, and a second layer and subsequent layers can be formed by MIG welding with the flux-cored wire of the present embodiment using a pure Ar gas as a shielding gas.

Note that when the flux-cored wire of the present embodiment is applied to only MIG welding, welding can be performed even in the case of a shielding gas that contains Ar as a main component and an active gas such as CO₂ and/or O₂ in an amount of 5% or less.

In the technology disclosed in Patent Literature 1, the position of welding is not considered, and a problem of sagging of beads may occur in position welding such as vertical welding or overhead welding. To address this problem, a welding process that is performed while molten metal is protected from sagging by using slag is typically employed. Furthermore, in the technology disclosed in Patent Literature 1, a central portion and an outer peripheral portion of a wire are formed of different materials, and a target metal composition is obtained in a state where the entire wire is homogeneously mixed. Therefore, a core and an outer peripheral component that are made of special materials are necessary. Accordingly, it is difficult to economically obtain the raw materials, and the cost of the wire tends to increase. In contrast, in the flux-cored wire of the present embodiment, raw materials and manufacturing methods of typical flux-cored wires can be used. Thus, it is possible to economically obtain the raw materials, and the manufacturing techniques have already been developed. Therefore, the flux-cored wire of the present embodiment can be manufactured at a low cost.

The wire that can be provided by the technology disclosed in Patent Literature 2 is used in a method for constructing a fixed pipe made of stainless steel, in which existing TIG welding and MAG welding are combined, and used basically under the assumption that welding is performed in CO₂ or a mixed gas of Ar—CO₂. The wire provided by this technology is not necessarily suitable for welding in a pure Ar shielding gas common to TIG welding.

In view of this, use of the flux-cored wire of the present embodiment, the wire having a composition suitable for MIG welding using a pure Ar gas as a shielding gas, can realize stability of arc and welding suitability at any welding position. Consequently, in on-site construction of a fixed pipe, all layers can be formed by using only a pure Ar gas to improve portability of, for example, a welding apparatus and a gas cylinder.

Furthermore, the flux-cored wire of the present embodiment can also be used in TIG welding of a first layer. The TIG welding in this case may be semiautomatic TIG welding because a high efficiency is obtained. This first-layer semiautomatic TIG welding with the flux-cored wire can be performed as welding without a back shielding gas as in welding with a typical slag-containing TIG welding rod. By using one type of welding material in the TIG welding of the first layer and the high-efficiency flux-cored wire welding of the second and subsequent layers, portability is further improved.

A description will be made of the reasons for the limitations on the composition of the flux-cored wire of the present embodiment. Unless otherwise stated, a case of MIG welding will be described.

The contents of TiO₂, Al₂O₃, SiO₂ and ZrO₂ in the flux-cored wire of the present embodiment can be measured with an ICP analyzer using a solution prepared by dissolving the flux-cored wire in a solution of an alkaline such as sodium hydroxide. The content of F in the flux-cored wire of the present embodiment can be measured by neutralization titration of a gas released by a high-temperature treatment.

### [TiO₂: 4.7 to 8.5% by Mass]

TiO₂ is a component necessary for increasing the melting point of slag and enabling all-position welding. When the content of TiO₂ relative to the total mass of the wire is less than 4.7% by mass, the above effect is not sufficiently provided, and sagging of beads may occur, which may result in difficulty of welding at a vertical position and an overhead position. When the content of TiO₂ relative to the total mass of the wire is more than 8.5% by mass, the slag has an excessively high melting point, smooth welding beads may not be obtained on the contrary, and defects of slag inclusion may occur.

Accordingly, in the flux-cored wire of the present embodiment, the content of TiO₂ relative to the total mass of the wire is set to 4.7 to 8.5% by mass.

From the viewpoint of obtaining a good bead shape in welding, the content of TiO₂ relative to the total mass of the wire is preferably 5.0% by mass or more, and more preferably 6.0% by mass or more.

From the viewpoint of obtaining smooth welding beads and the viewpoint of suppressing slag inclusion defects, the content of TiO₂ relative to the total mass of the wire is preferably 8.4% by mass or less, and more preferably 8.0% by mass or less.

[Al₂O₃: 0.5 to 3.5% by Mass]

Al₂O₃ has an effect of adjusting the viscosity of molten slag to adjust wettability of a molten metal. When the content of Al₂O₃ relative to the total mass of the wire is less than 0.5% by mass, defects of incomplete fusion due to a decrease in wettability may occur. When the content of Al₂O₃ relative to the total mass of the wire is more than 3.5% by mass, slag detachability decreases, which may result in a seizure phenomenon.

Accordingly, in the flux-cored wire of the present embodiment, the content of Al₂O₃ relative to the total mass of the wire is set to 0.5 to 3.5% by mass.

From the viewpoint of increasing wettability of a molten metal and easily obtaining welding suitability at a vertical position and an overhead position, the content of Al₂O₃ relative to the total mass of the wire is preferably 0.6% by mass or more.

From the viewpoint of ensuring, for example, such good slag detachability that slag can be detached with a hammer after welding, the content of Al₂O₃ relative to the total mass of the wire is preferably 3.0% by mass or less, more preferably 2.5% by mass or less, and still more preferably 2.0% by mass or less. [SiO₂: 0.5 to 2.0% by Mass]

SiO₂ also has an effect of adjusting the viscosity of molten slag to adjust wettability of a molten metal as in Al₂O₃. When the content of SiO₂ relative to the total mass of the wire is less than 0.5% by mass, defects of incomplete fusion due to a decrease in wettability may occur. When the content of SiO₂ relative to the total mass of the wire is more than 2.0% by mass, the melting point of the slag decreases, resulting in sagging of beads during welding at a vertical position, an overhead position, and the like. In addition, in such a case, since the viscosity of the slag increases, the slag does not easily flow into a penetration bead during semiautomatic TIG welding of a first layer.

Accordingly, in the flux-cored wire of the present embodiment, the content of SiO₂ relative to the total mass of the wire is set to 0.5 to 2.0% by mass.

From the viewpoint of increasing wettability of a molten metal, the content of SiO₂ relative to the total mass of the wire is preferably 0.7% by mass or more, and more preferably 0.9% by mass or more.

From the viewpoint of preventing a molten pool from sagging during welding and the viewpoint of suppressing an increase in the viscosity of the slag, the content of SiO₂ relative to the total mass of the wire is preferably 1.9% by mass or less, and more preferably 1.8% by mass or less.

### [ZrO₂: 0.8 to 3.0% by Mass]

ZrO₂ has an effect of adjusting the viscosity of molten slag and is a component having a function of improving a covering property of slag. When the content of ZrO₂ relative to the total mass of the wire is less than 0.8% by mass, the state covered with slag degrades, which may generate local seizure. When the content of ZrO₂ relative to the total mass of the wire is more than 3.0% by mass, molten slag has an excessively high viscosity, which may result in defects of slag inclusion.

Accordingly, in the flux-cored wire of the present embodiment, the content of ZrO₂ relative to the total mass of the wire is set to 0.8 to 3.0% by mass.

From the viewpoint of improving the covering property of slag, the content of ZrO₂ relative to the total mass of the wire is preferably 0.9% by mass or more, and more preferably 1.0% by mass or more.

From the viewpoint of obtaining a suitable viscosity of molten slag, the content of ZrO₂ relative to the total mass of the wire is preferably 2.9% by mass or less, more preferably 2.5% by mass or less, and still more preferably 2.2% by mass or less.

### [Metal Oxides: 8.0 to 13.5% by Mass in Total]

When the total amount of metal oxides, that is, the content of components forming slag in the wire (slag content ratio) relative to the total mass of the wire is less than 8.0% by mass, the absolute amount thereof is small, and thus a molten metal is difficult to support and it becomes difficult to ensure welding suitability at a vertical position and an overhead position. In addition, at a small content of metal oxides, when a first layer is formed by semiautomatic TTG welding, a sufficient amount of slag does not spread to a penetration bead, which may result in excessive oxidation of the bead surface.

On the other hand, when the content of metal oxides relative to the total mass of the wire is more than 13.5% by mass in total, defects of slag inclusion may occur. When the content of metal oxides is excessively high, slag inclusion tends to occur even in semiautomatic TIC welding.

Accordingly, in the flux-cored wire of the present embodiment, the content of metal oxides relative to the total mass of the wire is set to 8.0 to 13.5% by mass in total.

Note that herein the total amount of metal oxides includes the contents of TiO₂, Al₂O₃, SiO₂ and ZrO₂ described above.

In order to obtain such a good weldability that even a low-skilled welder can easily perform welding, the content of metal oxides relative to the total mass of the wire is preferably 8.5% by mass or more, and more preferably 9.0% by mass or more in total.

From the viewpoint of suppressing defects of slag inclusion, the content of metal oxides relative to the total mass of the wire is preferably 13.0% by mass or less, and more preferably 12.5% by mass or less in total.

[Metal Fluoride: 0.02% by Mass or Less (inclusive of 0% by Mass)]

A metal fluoride is a component necessary for ensuring porosity resistance in welding in active gas (CO₂ or Ar—CO₂) shielding, but degrades the arc concentration and decreases wettability of beads when a pure Ar gas is used as a shielding gas. When the content of a metal fluoride relative to the total mass of the wire is 0.02% by mass or less (inclusive of 0% by mass), the effect is not observed. On the other hand, when the content is more than 0.02% by mass, with the decrease in wettability of the molten metal, defects of incomplete fusion may occur.

Accordingly, in the flux-cored wire of the present embodiment, the content of a metal fluoride relative to the total mass of the wire is limited to 0.02% by mass or less (inclusive of 0% by mass).

Note that the term “0% by mass” means inclusion of a metal fluoride contained at an impurity level or less.

From the viewpoint, of suppressing occurrence of incomplete fusion during welding, the content of a metal fluoride relative to the total mass of the wire is preferably limited to 0.015% by mass or less, and more preferably 0.010% by mass or less. Still more preferably, a metal fluoride is not substantially added.

### [Other Components]

The balance in the component composition of the flux-cored wire of the present embodiment is alloy components and incidental impurities. Accordingly, the flux-cored wire of the present embodiment may have a composition containing, relative to the total mass of the wire, 4.7 to 8.5% by mass of TiO₂, 0.5 to 3.5% by mass of Al₂O₃, 0.5 to 2.0% by mass of SiO₂, 0.8 to 3.0% by mass of ZrO₂, and alloy components necessary for obtaining a desired weld metal composition and incidental impurities, in which a total amount of metal oxides is 8.0 to 13.5% by mass, and a content of a metal fluoride is limited to 0.02% by mass or less (inclusive of 0% by mass).

The outer skin may be referred to as a hoop, and an inner space of the outer skin is filled with a flux. The material of the outer skin is not particularly limited and may be appropriately selected. For example, in the case of MIG welding in which a pure Ar gas is used as a shielding gas, various steel materials, Ni-based alloys, etc. are suitably used as the material of the outer skin Accordingly, examples of the components of the outer skin include Fe, Si, Mn, Cu, Ni, Cr, Mo, Nb, W, V, Ti, Al, Mg, and N.

Examples of the incidental impurities include P and S.

As the outer skin made of a steel, stainless steels (SUS) are suitably used. Among these, austenitic stainless steels are more suitably used. Preferred specific examples of the austenitic stainless steels include SUS301, SUS304, SUS304L, SUS316, SUS316L, SUS310S, and SUS347.

Besides austenitic stainless steels, ferritic stainless steels such as SUS410L and SUS430 may also be used.

When an austenitic stainless steel is used as the outer skin, the austenitic stainless steel may have, for example, a composition which contains, relative to the total mass of the wire, Si: 2% by mass or less (e.g., 0.1 to 2% by mass), Mn: 2.5% by mass or less (e.g., 0.5 to 2.5% by mass), Cr: 16 to 26% by mass, and Ni: 6 to 22% by mass, in which the carbon (C) content is limited to 0.15% by mass or less, in which, as required, Mo: 7% by mass or less and/or Nb: 1% by mass or less, Cu: 1% by mass or less, and N: 0.3% by mass or less are added, and which contains the balance being Fe and incidental impurities.

When a ferritic steel is used as the outer skin, the ferritic steel may have, for example, a composition which contains, relative to the total mass of the wire, Si: 1% by mass or less (e.g., 0.1 to 1% by mass), Mn: 1% by mass or less (e.g., 0.1 to 1% by mass), and Cr: 10.5 to 20% by mass, in which the carbon (C) content is limited to 0.15% by mass or less, in which, as required, Mo: 2.5% by mass or less and/or Nb: 1% by mass or less, Cu: 1% by mass or less, Ti: 1% by mass or less, and Zr: 1% by mass or less are added, and which contains the balance being Fe and incidental impurities.

The outer skin may be made of a Ni-based alloy such as Alloy600, Alloy625, or AlloyC-276.

When a Ni-based alloy is used as the outer skin, the Ni-based alloy may have, for example, a composition which contains, relative to the total mass of the wire, Si: 1.5% by mass or less (e.g., 0.01 to 1.5% by mass) and Mn: 9.5% by mass or less (e.g., 0.1 to 9.5% by mass), in which, as required, at least one of C: 0.2% by mass or less, Cr: 35% by mass or less, Mo: 20% by mass or less, Nb: 4% by mass or less, Ti: 0.5% by mass or less, W: 5% by mass or less, V: 0.6% by mass or less, Cu: 2.5% by mass or less, and Fe: 20% by mass or less is added, and which contains the balance being Ni and incidental impurities.

### [Outer Diameter of Wire]

The flux-cored wire of the present embodiment preferably has an outer diameter in the range of 1.0 to 1.6 mm. From the viewpoint of, on the basis of melting properties of the flux-cored wire, ensuring the amount of heat input relative to the amount of wire melted to obtain good wettability of the molten metal, the outer diameter of the wire is preferably 1.0 mm or more, more preferably 1.1 mm or more, and still more preferably 1.2 mm or more. From the viewpoint of obtaining a good droplet transfer form to suppress generation of large spatter droplets, the outer diameter of the wire is preferably 1.6 mm or less, more preferably 1.5 mm or less, and still more preferably 1.4 mm or less.

Performing welding such as semiautomatic TIG welding by using a flux-cored wire having an outer diameter in the range of 1.2 to 1.4 mm enables a good droplet transfer form to be generated to realize a satisfactory welding operation.

The sectional shape and the flux content ratio of the flux-cored wire of the present embodiment are not particularly limited and may be respectively appropriately selected according to, for example, use and welding parameters. The flux-cored wire of the present embodiment can be used not only in the method for manufacturing a welded joint according to an embodiment described below but also in various welding methods and methods for manufacturing a welded joint.

### <Method for Manufacturing Welded Joint>

Next, a description will be made of an embodiment of a method for manufacturing a welded joint using the flux-cored wire according to the embodiment described above. Note that, in the present disclosure, the term “welded joint” refers to a joint obtained after a metal to be welded, which is a base material, is welded by using a flux-cored wire.

The method for manufacturing a welded joint of the present embodiment includes performing MIG welding with the flux-cored wire according to the above embodiment using a pure Ar gas (100% Ar gas) as a shielding gas. For example, as described above, when welding is performed on a tubular component such as a fixed pipe made of stainless steel, for which the flux-cored wire according to the above embodiment can be suitably used, it is preferable that a first layer be formed by TIG welding using a pure Ar gas as a shielding gas, and a second layer and subsequent layers be formed by MIG welding with the flux-cored wire of the embodiment using a pure Ar gas as a shielding gas.

In this case, it is also preferable that the first layer be formed by semiautomatic TIG welding with the flux-cored wire of the embodiment, and the second layer and subsequent layers be formed by MIG welding with the flux-cored wire of the embodiment using a pure Ar gas as a shielding gas.

In the method for manufacturing a welded joint of the present embodiment, the material of the metal to be welded, the shape of the joint, the groove shape, and welding parameters such as a welding current, a welding voltage, and a welding speed are not particularly limited and may be appropriately selected.

### EXAMPLES

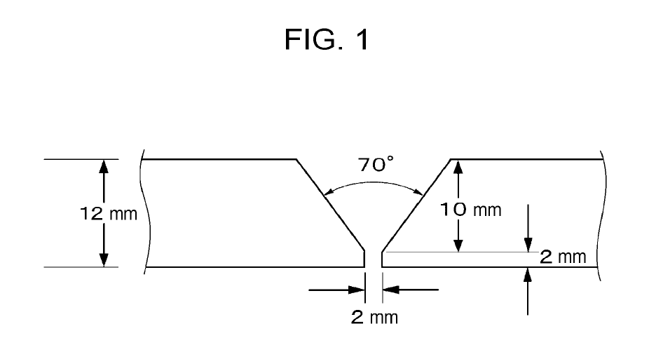

Hereinafter, advantages of the present technology will be specifically described with reference to Examples and Comparative Examples. In the Examples, a SUS304 steel sheet with a thickness of 12 mm, the steel sheet being processed to have a V-shaped groove with a root face height of 2 mm, a root gap of 2 mm, and a groove angle of 70° as illustrated in FIG. 1, was used as a metal to be welded. The groove of the metal to be welded was subjected to four-layer four-pass welding at each of a flat position, a vertical position, and an overhead position by using the flux-cored wire described in Table 1 below and then evaluated. A first layer was formed by semiautomatic TIG welding at a welding current of 150 A and an arc voltage of 13 V, and a second layer to a fourth layer were formed by MIG welding using a pure Ar gas as a shielding gas at a welding current of 190 A and an arc voltage of 24 V.

Regarding the amounts of flux components (% by mass) relative to the total mass of the wire, the contents of TiO₂, Al₂O₈, SiO₂, and ZrO₂ were measured with an ICP analyzer using a solution prepared by dissolving a flux-cored wire in a sodium hydroxide solution. The content, of F was measured by neutralization titration of a gas released by a high-temperature treatment. Chemical components (% by mass) of all-deposited metal were measured in accordance with ASTM E353 and ASTM E354.

TABLE 1

| | | | | Amounts of flux components relative to total | | | | | | | | | | | | | | | | | | |
|---|---|---|---|---|---|---|---|---|---|---|---|---|---|---|---|---|---|---|---|---|---|---|
| | | | | mass of wire (wire %) | | | | | | | | | | | | | | | | | | |
| | | | | | | | | Total | | | | | | | | | | | | | | |
| | | Steel type | | | | | | amount | | Outer | | | | | | | | | | | | |
| | | of weld | Steel type | | | | | of metal | Metal | diameter | Chemical componentsof all-deposited metal (mass %) | | | | | | | | | | | |
| | No. | metal | of hoop | TiO₂ | Al₂O₃ | SiO₂ | ZrO₂ | oxides | fluoride | (mm) | C | Si | Mn | P | S | Cu | Ni | Cr | Mo | Nb + Ta | W | N |
| Ex. | 1 | 308L | SUS304L | 6.38 | 1.33 | 1.19 | 1.56 | 10.7 | — | 1.2 | 0.018 | 0.83 | 0.85 | 0.019 | 0.005 | 0.02 | 9.86 | 19.63 | 0.01 | 0.01 | <0.01 | 0.021 |
| | 2 | 308L | SUS304L | 6.38 | 1.33 | 1.19 | 1.56 | 10.7 | — | 1.0 | 0.019 | 0.85 | 0.86 | 0.019 | 0.004 | 0.02 | 9.75 | 9.57 | 0.01 | 0.01 | <0.01 | 0.018 |
| | 3 | 308L | SUS304L | 6.38 | 1.30 | 1.21 | 1.52 | 10.6 | — | 1.4 | 0.016 | 0.85 | 0.85 | 0.017 | 0.004 | 0.02 | 9.88 | 19.61 | <0.01 | <0.01 | <0.01 | 0.020 |
| | 4 | 308L | SUS304L | 6.40 | 1.29 | 1.23 | 1.57 | 10.7 | — | 1.6 | 0.016 | 0.90 | 0.84 | 0.016 | 0.004 | 0.02 | 9.85 | 19.63 | 0.01 | <0.01 | <0.01 | 0.019 |
| | 5 | 309L | SUS304L | 6.38 | 1.28 | 1.23 | 1.63 | 10.7 | — | 1.2 | 0.020 | 0.81 | 0.85 | 0.018 | 0.003 | 0.03 | 12.69 | 23.28 | 0.01 | 0.01 | <0.01 | 0.022 |
| | 6 | 316L | SUS304L | 6.35 | 1.25 | 1.21 | 1.59 | 10.6 | — | 1.2 | 0.017 | 0.85 | 0.85 | 0.022 | 0.003 | 0.09 | 11.76 | 17.60 | 2.42 | <0.01 | <0.01 | 0.025 |
| | 7 | 310 | SUS310S | 6.33 | 1.29 | 1.17 | 1.53 | 10.5 | — | 1.2 | 0.17 | 0.45 | 2.10 | 0.019 | 0.002 | 0.03 | 21.50 | 25.74 | 0.02 | 0.02 | <0.01 | 0.016 |
| | 8 | 347 | SUS304L | 6.42 | 1.34 | 1.23 | 1.62 | 10.8 | — | 1.2 | 0.020 | 0.30 | 1.52 | 0.019 | 0.003 | 0.03 | 9.86 | 19.66 | 0.01 | 0.84 | <0.01 | 0.027 |
| | 9 | 2594 | SUS304L | 6.50 | 0.73 | 0.91 | 1.80 | 10.1 | — | 1.2 | 0.021 | 0.48 | 0.83 | 0.015 | 0.004 | 0.02 | 8.17 | 24.44 | 2.27 | 0.01 | 0.71 | 0.22 |
| | 10 | 308L | SUS304L | 5.10 | 0.58 | 0.97 | 1.26 | 8.1 | — | 1.2 | 0.016 | 0.85 | 0.86 | 0.019 | 0.004 | 0.03 | 9.80 | 19.50 | 0.01 | 0.01 | <0.01 | 0.020 |
| | 11 | 308L | SUS304L | 8.36 | 0.86 | 1.42 | 1.86 | 12.7 | — | 1.2 | 0.017 | 1.04 | 0.87 | 0.018 | 0.005 | 0.07 | 9.87 | 19.66 | 0.01 | 0.02 | <0.01 | 0.018 |
| | 12 | 308L | SUS304L | 7.66 | 1.85 | 1.41 | 1.93 | 13.1 | — | 1.2 | 0.018 | 1.03 | 0.87 | 0.021 | 0.003 | 0.03 | 9.92 | 19.74 | 0.01 | 0.01 | <0.01 | 0.020 |
| | 13 | 308L | SUS304L | 7.72 | 2.26 | 1.42 | 1.81 | 13.4 | — | 1.2 | 0.019 | 1.05 | 0.87 | 0.019 | 0.003 | 0.04 | 9.95 | 19.82 | 0.01 | 0.01 | <0.01 | 0.019 |
| | 14 | 308L | SUS304L | 7.61 | 0.84 | 1.78 | 2.00 | 12.5 | — | 1.2 | 0.019 | 1.12 | 0.88 | 0.017 | 0.004 | 0.04 | 9.84 | 19.58 | <0.01 | 0.02 | <0.01 | 0.019 |
| | 15 | 308L | SUS304L | 5.15 | 0.94 | 0.90 | 0.85 | 8.0 | — | 1.2 | 0.019 | 0.80 | 0.86 | 0.018 | 0.003 | 0.04 | 9.78 | 19.48 | 0.01 | <0.01 | <0.01 | 0.022 |
| | 16 | 308L | SUS304L | 7.57 | 0.83 | 1.46 | 2.86 | 12.9 | — | 1.2 | 0.016 | 1.10 | 0.89 | 0.016 | 0.004 | 0.05 | 9.90 | 19.70 | <0.01 | 0.02 | <0.01 | 0.018 |
| | 17 | 308L | SUS304L | 7.66 | 1.07 | 1.41 | 1.85 | 12.2 | 0.008 | 1.2 | 0.020 | 1.05 | 1.00 | 0.019 | 0.004 | 0.03 | 9.65 | 20.15 | 0.01 | 0.01 | <0.01 | 0.022 |
| | 18 | 308L | SUS304L | 7.72 | 1.07 | 1.42 | 1.86 | 12.3 | 0.014 | 1.2 | 0.017 | 1.00 | 1.06 | 0.021 | 0.004 | 0.05 | 9.58 | 20.36 | 0.01 | 0.01 | <0.01 | 0.021 |
| | 19 | 308L | SUS304L | 6.06 | 0.66 | 1.11 | 1.16 | 9.2 | — | 1.2 | 0.017 | 0.95 | 0.93 | 0.020 | 0.004 | 0.03 | 9.95 | 20.12 | 0.01 | <0.01 | <0.01 | 0.020 |
| Com. | 1 | 308L | SUS304L | 4.55 | 0.60 | 0.96 | 1.31 | 7.5 | — | 1.2 | 0.020 | 0.83 | 0.86 | 0.017 | 0.004 | 0.05 | 9.76 | 19.39 | 0.01 | <0.01 | <0.01 | 0.018 |
| Ex. | 2 | 308L | SUS304L | 8.68 | 1.21 | 1.43 | 1.87 | 13.4 | — | 1.2 | 0.021 | 1.05 | 0.87 | 0.016 | 0.003 | 0.07 | 9.94 | 19.81 | <0.01 | 0.02 | <0.01 | 0.021 |
| | 3 | 308L | SUS304L | 5.10 | 0.45 | 0.97 | 1.26 | 7.9 | — | 1.2 | 0.020 | 0.78 | 0.86 | 0.020 | 0.004 | 0.03 | 9.79 | 19.47 | <0.01 | <0.01 | <0.01 | 0.020 |
| | 4 | 308L | SUS304L | 7.20 | 3.18 | 1.33 | 1.85 | 13.8 | — | 1.2 | 0.016 | 1.00 | 0.88 | 0.020 | 0.005 | 0.02 | 9.99 | 19.91 | 0.01 | 0.01 | <0.01 | 0.022 |
| | 5 | 308L | SUS304L | 6.94 | 3.57 | 1.28 | 1.80 | 13.8 | — | 1.2 | 0.022 | 0.98 | 0.88 | 0.018 | 0.004 | 0.07 | 9.99 | 19.91 | <0.01 | 0.01 | <0.01 | 0.019 |
| | 6 | 308L | SUS304L | 5.05 | 0.59 | 0.48 | 1.05 | 7.3 | — | 1.2 | 0.016 | 0.65 | 0.86 | 0.016 | 0.004 | 0.06 | 9.73 | 19.34 | 0.01 | <0.01 | <0.01 | 0.018 |
| | 7 | 308L | SUS304L | 5.10 | 0.60 | 0.59 | 1.23 | 7.7 | — | 1.2 | 0.018 | 0.69 | 0.86 | 0.019 | 0.003 | 0.08 | 9.76 | 19.41 | 0.01 | <0.01 | <0.01 | 0.020 |
| | 8 | 308L | SUS304L | 7.38 | 0.85 | 2.05 | 2.05 | 12.5 | — | 1.2 | 0.020 | 1.20 | 0.87 | 0.021 | 0.005 | 0.03 | 9.84 | 19.60 | 0.01 | 0.02 | <0.01 | 0.022 |
| | 9 | 308L | SUS304L | 5.10 | 0.60 | 0.87 | 0.69 | 7.4 | — | 1.2 | 0.019 | 0.85 | 0.86 | 0.020 | 0.004 | 0.04 | 9.73 | 19.36 | 0.01 | <0.01 | <0.01 | 0.020 |
| | 10 | 308L | SUS304L | 7.70 | 0.92 | 1.55 | 3.12 | 13.5 | — | 1.2 | 0.018 | 1.09 | 0.88 | 0.018 | 0.004 | 0.06 | 9.94 | 19.81 | <0.01 | 0.02 | <0.01 | 0.021 |
| | 11 | 308L | SUS304L | 7.40 | 1.09 | 1.43 | 1.79 | 11.9 | 0.027 | 1.2 | 0.017 | 1.02 | 1.07 | 0.019 | 0.005 | 0.05 | 9.55 | 20.29 | 0.01 | 0.02 | <0.01 | 0.018 |

Ex.: Example
Com. Ex.: Comparative Example

A sensory evaluation was first conducted during welding. In the evaluation relating to the first-layer semiautomatic TIG welding, welding workability at the vertical position and the overhead position (vertical/overhead weldability), stability of droplet transfer, and a covering property of slag on a penetration bead were evaluated. In the evaluation relating to the MIG welding, vertical/overhead weldability, slag detachability, and stability of droplet transfer (generation state of large spatter droplets) were evaluated. In addition, welding defects were examined by nondestructive/destructive tests. In this examination of welding defects, radiographic testing was conducted as the nondestructive test. When a defect was observed, a section of the weld portion was subjected to macro-observation to specify the position at which the defect was generated and the type of defect (slag inclusion or incomplete fusion). In the semiautomatic TIG welding, incomplete fusion was not observed. For wires evaluated as “welding could not be performed” (evaluated as C) in the evaluation of vertical/overhead weldability, the other evaluation items were evaluated by welding at the flat position.

### <Evaluation of First-Layer Semiautomatic TIG Welding>

In the first-layer semiautomatic TIG welding, the evaluation of the items was performed in accordance with the standards described in items (1) to (4) below.

### (1) Vertical/Overhead Weld Ability

In the case where semiautomatic TIC welding was performed at the vertical position and the overhead position, samples in which there was substantially no concern about sagging of the weld metal and the operation could be satisfactorily performed were evaluated as A (Excellent), samples in which there was a concern about sagging of the weld metal but welding could be performed were evaluated as B (Good), and samples in which welding could not be performed due to the occurrence of sagging of the weld metal were evaluated as C (Poor).

### (2) Stability of Droplet Transfer

Samples in which a bridge was continuously formed and a stable transfer was observed during welding were evaluated as A (Excellent), samples in which large droplets were formed but a somewhat stable transfer was observed during welding were evaluated as B (Good), and samples in which, for example, formation of larger droplets was confirmed and the droplets dropped outside the molten pool, and thus there was a concern about incomplete fusion were evaluated as C (Poor).

### (3) Covering Property of Slag on Penetration Bead

Samples in which the penetration bead was uniformly covered with slag were evaluated as A (Excellent), samples in which a portion having a small thickness of slag was generated but a satisfactory welding bead was obtained were evaluated as B (Good), and samples in which a slag layer was broken and the weld metal was excessively oxidized were evaluated as C (Poor).

### (4) Slag Inclusion

Samples in which slag inclusion was not confirmed were evaluates as A (Excellent), samples that were acceptable in accordance with the standards of AWS A5.22 were evaluated as B (Good), and samples that were unacceptable in accordance with the standards of AWS A5.22 were evaluated as C (Poor).

### <Evaluation of MIG Welding Using Pure Ar Shielding Gas>

In the MIG welding using a pure Ar shielding gas, the evaluation of the items was performed in accordance with the standards described in items (5) to (9) below.

### (5) Vertical/Overhead Weldability

In the case where MIG welding was performed at the vertical position and the overhead position, samples in which there was substantially no concern about sagging of the weld metal and the operation could be satisfactorily performed were evaluated as A (Excellent), samples in which there was a concern about sagging of the weld metal but welding could be performed were evaluated as B (Good), and samples in which welding could not be performed due to the occurrence of sagging of the weld metal were evaluated as C (Poor).

### (6) Slag Detachability

Samples from which slag could be easily removed by being hit with a scaling hammer were evaluated as A (Excellent), samples from which slag could not be completely removed by being hit with a scaling hammer but could be removed with a chisel were evaluated as B (Good), and samples from which slag could not be removed even with a chisel due to seizure were evaluated as C (Poor).

### (7) Stability of Droplet Transfer (Generation State of Large Spatter Droplets)

Samples in which a stable spray transfer was observed during welding were evaluated as A (Excellent), samples in which a globular transfer was observed were evaluated as B (Good), and samples in which a globular transfer was observed and large spatter droplets were generated in a large amount were evaluated as C (Poor).

### (8) Slag Inclusion

Samples in which slag inclusion was not confirmed were evaluated as A (Excellent), samples that were acceptable in accordance with the standards of AWS A5.22 were evaluated as B (Good), and samples that were unacceptable in accordance with the standards of AWS A5.22 were evaluated as C (Poor).

### (9) Incomplete Fusion

Samples in which incomplete fusion was not confirmed were evaluated as A (Excellent), samples that were acceptable in accordance with the standards of AWS A5.22 were evaluated as B (Good), and samples that were unacceptable in accordance with the standards of AWS A5.22 were evaluated as C (Poor).

After the above items were evaluated, whether each sample was acceptable or unacceptable was finally determined as follows. Samples that did not have an evaluation result of C in the items were evaluated as acceptable, and samples that had at least one evaluation result of C in the items were evaluated as unacceptable.

Table 2 shows the evaluation results.

TABLE 2

| | | | | | | Evaluation results of pure Ar shied gas MIG welding | | | | | |
|---|---|---|---|---|---|---|---|---|---|---|---|
| | | | | | | | | Stability | | | |
| | | Evaluation results of first-layer | | | | | | of | | | |
| | | semiautomatic TIG welding | | | | | | droplet | | | |
| | | | | Covering | | | | transfer | | | |
| | | | Stability | property | | | | Generation | | | |
| | | Vertical/ | of | of slag on | | Vertical/ | | of large | | | |
| | | overhead | droplet | penatration | Slag | overhead | Slag | spatter | Slag | Incomplete | Comprehensive |
| | No. | weldability | transfer | bead | inclusion | weldability | detachability | droplets | inclusion | fusion | evaluation |
| Example | 1 | A | A | A | A | A | A | A | A | A | Acceptable |
| | 2 | A | A | A | A | A | A | A | A | B | Acceptable |
| | 3 | A | A | A | A | A | A | A | A | A | Acceptable |
| | 4 | A | B | A | A | A | A | B | A | A | Acceptable |
| | 5 | A | A | A | A | A | A | A | A | A | Acceptable |
| | 6 | A | A | A | A | A | A | A | A | A | Acceptable |
| | 7 | A | A | A | A | A | A | A | A | A | Acceptable |
| | 8 | A | A | A | A | A | A | A | A | A | Acceptable |
| | 9 | A | A | A | A | A | A | A | A | A | Acceptable |
| | 10 | A | A | B | A | B | A | A | A | A | Acceptable |
| | 11 | A | A | A | B | A | A | A | B | A | Acceptable |
| | 12 | A | A | A | B | A | A | A | A | B | Acceptable |
| | 13 | A | A | A | B | A | B | A | A | B | Acceptable |
| | 14 | A | A | A | A | A | A | A | A | A | Acceptable |
| | 15 | A | A | B | A | B | A | A | A | A | Acceptable |
| | 16 | A | A | A | B | A | A | A | B | B | Acceptable |
| | 17 | A | A | A | A | A | A | A | A | A | Acceptable |
| | 18 | A | A | A | A | A | A | A | A | B | Acceptable |
| | 19 | A | A | A | A | A | A | A | A | A | Acceptable |
| Comparative | 1 | B | A | C | A | C | A | A | A | A | Unacceptable |
| Example | 2 | A | A | A | B | A | A | A | C | A | Unacceptable |
| | 3 | B | A | C | A | C | A | A | A | C | Unacceptable |
| | 4 | A | A | A | C | A | B | A | C | C | Unacceptable |
| | 5 | A | A | A | C | A | C | A | C | C | Unacceptable |
| | 6 | C | A | C | A | C | A | A | A | C | Unacceptable |
| | 7 | C | A | C | A | C | A | A | A | A | Unacceptable |
| | 8 | B | A | B | A | C | A | A | A | A | Unacceptable |
| | 9 | C | A | C | A | C | C | A | B | A | Unacceptable |
| | 10 | A | A | A | C | A | A | A | C | B | Unacceptable |
| | 11 | A | A | A | A | B | A | A | A | C | Unacceptable |

When the flux-cored wires of Examples 1 to 19 were used, in each of the evaluation items of the semiautomatic TIG welding of the first layer and the MIG welding of the second to fourth layers in which a pure Ar gas was used as a shielding gas, the evaluation results did not include C (Poor) and were acceptable.

In contrast, when the flux-cored wires of Comparative Examples 1 to 11 were used, the results included C (Poor) in any of the evaluation items and were unacceptable.

### (With Regard to Outer Diameter of Wire)

Examples 1 to 4 are experimental examples in which the wire diameter was changed. In Example 1, in which the outer diameter was 1.2 mm, and Example 3, in which the outer diameter was 1 4 mm, satisfactory results of A were obtained in all the evaluation items. In contrast, in Example 2, in which the outer diameter was 1.0 mm, the amount of heat input relative to the amount of wire melted decreases. Consequently, wettability was somewhat poor, and incomplete fusion was observed, though the incomplete fusion was at an acceptable level. In Example 4, in which the outer diameter was 1.6 mm, the droplets had a large size and were dropped, which provided poor welding workability. In addition, the large droplets might be dispersed in the form of spatter. Thus, even in the first-layer TTG welding, the stability of droplet transfer tended to decrease. The results of Examples 1 to 4 suggested that the outer diameter of the wire be 1.0 to 1.6 mm, preferably 1.1 to 1.5 mm, and more preferably 1.2 to 1.4 mm.

### (With Regard to Steel Type of Weld Metal)

Examples 5 to 9 are examples in which the weld metal components were adjusted such that the steel type of the weld metal was other than a 308L-based steel. Although the type of hoop and the amounts of alloy components were significantly changed, satisfactory welding could be performed because the amounts of flux components were in the appropriate range.

### (With Regard to TiO₂ Content)

Example 10 and Comparative Example 1 are examples in which the TiO₂ content was somewhat lower than those in other examples. Since the TiO₂ content is low, the total amount of metal oxides (slag content) is also small. In Example 10, since the amount of slag was small, a sufficient amount of slag did not spread to the penetration bead during the first-layer TIG welding, and the covering property of slag tended to degrade. However, the result reached the acceptable level. Furthermore, in Example 10, since the TiO₂ content is low, the slag does not have a sufficiently high melting point. Thus, in the MIG welding at the vertical position and the overhead position, there was a concern about sagging. Furthermore, in Comparative Example 1, since the TiO₂ content was less than 4.7% by mass, in the first-layer TIG welding, the slag layer was broken, and excessive oxidization was confirmed. In the MIG welding of the second to fourth layers, the welding operation at the vertical position and the overhead position could not be performed due to the problem of sagging. Accordingly, Comparative Example 1 was evaluated as unacceptable.

Example 11 and Comparative Example 2 are examples in which the TiO₂ content was somewhat higher than those in other examples. In Example 11, since the TiO₂ content was high, the slag had a high melting point, and defects of slag inclusion were slightly observed. However, the defect was at the acceptable level. On the other hand, in Comparative Example 2, since the TiO₂ content was higher and exceeded 8.5% by mass, in the MIG welding, slag inclusion occurred at the unacceptable level.

(With Regard to Al₂O₃ Content)

Comparative Example 3 is an example in which the Al₂O₃ content is somewhat lower than those in other examples. Since the Al₂O₃ content was low, and less than 0.5% by mass, wettability during the MIG welding degraded, and incomplete fusion frequently occurred. With the decrease in the Al₂O₃ content, the total amount of metal oxides (amount of slag) was also small, and less than 8.0% by mass. Accordingly, the covering property of slag on the penetration bead in the first-layer TIG welding was poor, and welding at the vertical position and the overhead position could not be performed. Examples 12 and 13 and Comparative Examples 4 and 5 are examples in which the Al₂O₃ content is somewhat higher than those in other examples. Comparing Example 12 and Example 13, it was suggested that the slag detachability during the MIG welding tend to decrease with the increase in the Al₂O₃ content. In Comparative Examples 4 and 5, the Al₂O₃ content is higher, and in Comparative Example 5, slag seizure occurred at a level at which the slag could not be removed. In Comparative Examples 4 and 5, with the increase in the Al₂O₃ content, the total amount of metal oxides (amount of slag) was excessive and exceeded 13.5% by mass. Accordingly, defects such as slag inclusion frequently occurred.

### (With Regard to SiO₂ Content)

Comparative Examples 6 and 7 are examples in which the SiO₂ content is somewhat lower than those in other examples. In Comparative Example 6, since the SiO₂ content was lower than 0.5% by mass, wettability decreased and incomplete fusion occurred. Accordingly, Comparative Example 6 was evaluated as unacceptable. In Comparative Example 7, since the SiO₂ content was higher than that in Comparative Example 6, the problem due to incomplete fusion did not occur. However, in each of Comparative Examples 6 and 7, welding at the vertical position and the overhead position could not be performed because the amount of slag was small.

Example 14 and Comparative Example 8 are examples in which the SiO₂ content is somewhat higher than those in other examples. In Example 14, welding could be satisfactorily performed. However, in Comparative Example 8, since the SiO₂ content was excessive and exceeded 2.0% by mass, the melting point of the slag decreased, and welding at the vertical position and the overhead position could not be performed. Furthermore, in the first-layer TIG welding, the slag did not easily flow into the penetration bead due to an increase in the viscosity of the slag, and thus the covering property of slag on the penetration bead also tended to degrade.

### (With Regard to ZrO₂ Content)

Example 15 and Comparative Example 9 are examples in which the ZrO₂ content is somewhat lower than those in other examples. It was found that, in Comparative Example 15, the slag detachability was maintained. However, in Comparative Example 9, since the ZrO₂ content is lower than 0.8% by mass, the covering property of slag degraded, resulting in local slag seizure. Consequently, the slag could not be removed.

Example 16 and Comparative Example 10 are examples in which the ZrO₂ content is somewhat higher than those in other examples. In Example 16, the generation of defects was in the acceptable range. However, in Comparative Example 10, since the molten slag had an excessively high viscosity, defects of slag inclusion were generated at the unacceptable level.

### (With Regard to Metal Fluoride Content)

Examples 17 and 18 and Comparative Example 11 are examples in which a metal fluoride is contained. It was confirmed that in Example 18, in which the metal fluoride content was lower than 0.02% by mass, welding could be satisfactorily performed, and in Example 17, in which the content was lower than that in Example 18, welding could be performed more satisfactorily than Example 18. However, in Comparative Example 11, in which the content was excessively high, since the arc concentration degraded, wettability of the bead decreased. As a result, defects of incomplete fusion were frequently occurred.

### (With Regard to Slag Content Ratio)

In Examples 10 and 15 described above, since the total amount of metal oxides, that is, the content of components forming slag (slag content ratio) was low, welding workability at the vertical position and the overhead position tended to decrease. In Comparative Examples 1, 3, 6, 7, and 9, since the total amount of metal oxides was less than 8.0% by mass, welding at the vertical position and the overhead position could not be performed. In Example 16, the slag content ratio was enough, and thus good welding workability was obtained at the vertical position and the overhead position. In contrast, in Comparative Examples 4 and 5, the total amount of metal oxides exceeded 13.5% by mass, and consequently, defects of slag inclusion frequently occurred.

The present invention includes the following embodiments.

### Embodiment 1

A flux-cored wire including an outer skin filled with a flux,

wherein the wire contains, relative to a total mass of the wire,

TiO₂: 4.7 to 8.5% by mass,

Al₂O₃. 0.5 to 3.5% by mass,

SiO₂: 0.5 to 2.0% by mass, and

ZrO₂: 0.8 to 3.0% by mass,

a total amount of metal oxides is 8.0 to 13.5% by mass, and

an amount of a metal fluoride is limited to 0.02% by mass or less.

### Embodiment 2

The flux-cored wire according to Embodiment 1, wherein the wire has an outer diameter of 1.0 to 1.6 mm.

### Embodiment 3

The flux-cored wire according to Embodiment 1 or 2, wherein the wire is used for welding a tubular component.

### Embodiment 4

A method for manufacturing a welded joint, the method including performing MIG welding with the flux-cored wire according to any one of Embodiments 1 to 3 using a pure Ar gas as a shielding gas.

This application claims the benefit of Japanese Patent Application No. 2014-251707 filed in the Japan Patent Office on Dec. 12, 2014. Japanese Patent Application No. 2014-251707 is incorporated herein by reference.

1. A flux-cored wire, comprising an outer skin filled with a flux, wherein the wire comprises, relative to a total mass of the wire:
TiO₂: 4.7 to 8.5% by mass,
Al₂O₃: 0.5 to 3.5% by mass,
SiO₂: 0.5 to 2.0% by mass, and
ZrO₂: 0.8 to 3.0% by mass,
a total amount of metal oxides is 8.0 to 13.5% by mass, and
an amount of a metal fluoride is limited to 0.02% by mass or less (inclusive of 0% by mass).

2. The flux-cored wire according to claim 1, wherein the wire has an outer diameter of 1.0 to 1.6 mm.

3. The flux-cored wire according to claim 1, wherein the wire is used for welding a tubular component.

4. A method for manufacturing a welded joint, the method comprising performing MIG welding with the flux-cored wire according to claim 1 using a pure Ar gas as a shielding gas.
